(19) United States
(12) Patent Application Publication
(10) Pub. No.: US 2007/0296908 A1
(43) Pub. Date: Dec. 27, 2007

(54) LIQUID CRYSTAL DISPLAY DEVICE

(75) Inventor: Hitoshi KOYAMA, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI ELECTRIC CORPORATION, Tokyo (JP)

(21) Appl. No.: 11/767,013

(22) Filed: Jun. 22, 2007

(30) Foreign Application Priority Data
Jun. 26, 2006 (JP) 2006-174887

(51) Int. Cl. G02F 1/1339; G02F 1/1335

(52) U.S. Cl. 349/156; 349/114

(57) ABSTRACT

A liquid crystal display device includes: a liquid crystal layer interposed between a first substrate and a second substrate; a columnar spacer holding the liquid crystal layer; and a plurality of pixels arranged in matrix which constitutes a display unit, wherein: each of the pixels has a first display region and a second display region; the first display region has the liquid crystal layer thinner than the second display region; a protrusion portion is formed in the first display region of the first substrate; and the columnar spacer is formed only in the second display region in which the protrusion portion is not formed.

### BACKGROUND OF THE INVENTION

1. Field of the Invention

The present invention relates to a liquid crystal display device. For example, the invention can be used suitably for a transflective liquid crystal display device.

2. Description of the Related Art

A liquid crystal display device is thin, lightweight, and low in power consumption, and is used as display devices of a lot of apparatuses. In particular, a portable information apparatus such as a cellular phone employs a transflective display device which can operate both in a reflective display mode using ambient light and in a transmissive display mode using a backlight so as to acquire good display under strong ambient light and in a dark room.

The transflective display device includes a liquid crystal panel in which a liquid crystal layer is interposed between a pair of substrates and the backlight. A display region of pixels arranged in matrix which constitute a display unit includes a reflective display region in which a reflective electrode is disposed and a transmissive display region in which a transmissive electrode is disposed.

Here, light is only once transmitted onto the liquid crystal layer in the transmissive display region, while the light reciprocates through the liquid crystal layer in the reflective display region. Accordingly, there is developed a transflective liquid crystal display device having a multi-gap structure in which a protrusion is formed on an array substrate or a color filter substrate so that the gap of the liquid crystal layer in the reflective display region is as large as approximately a half of a thickness (hereinafter, referred to as a gap) of the liquid crystal layer in the transmissive display region so as to acquire the same optical distance, as disclosed in JP-A-2005-107494, JP-A-2002-72220 and JP-A-2002-214624.

### SUMMARY OF THE INVENTION

In a known transflective liquid crystal display device, a columnar spacer maintaining a gap is formed in a reflective display region. There was a problem that a difference between the gaps in the transmissive display region increases when a protrusion portion is formed on a substrate by using a transparent photosensitive resin and the columnar spacer is disposed on the protrusion portion so as to acquire the smaller gap of the reflective display region. The reason is as follows. Since the gap of the transmissive display region is determined by the sum of a film thickness of the protrusion portion and a film thickness of the columnar spacer, the gap of the transmissive display region is influenced by both a difference in film thickness of the protrusion portion and a difference in film thickness of the columnar spacer. The difference between the gaps in the transmissive display region is visualized as display unevenness, but there was a problem that the transmissive display mode is emphasized in a display quality of the liquid crystal display device.

In the same substrate, when the columnar spacer is formed on the protrusion portion, the columnar spacer is coated with a resin film by using spin coat. Then, since a film thickness of the resin film on the protrusion portion depends on a physical property such as a viscosity of the resin film and an evenness or an area of the protrusion portion, there was a problem that the film thickness of the resin film on an uneven substrate may make a difference easier than that on a flat substrate on which the protrusion portion is not formed. As a result, since the difference in film thickness of the columnar spacer in the reflective display region increases, whereby a gap unevenness occurs in the transmissive display region and the reflective display region, the display quality of the liquid crystal display device is markedly reduced both in the transmissive display mode and in the reflective display mode.

On the other hand, when the protrusion portion and the columnar spacer are formed on separate substrates, the film thickness of the columnar spacer is not influenced by the protrusion portion, but when the columnar spacer is adjacent to an end portion of the protrusion portion at the time of bonding two substrates, an alignment precision of the protrusion portion and the columnar spacer may become a problem.

The present invention is contrived to solve the above-mentioned problems and an object of the invention is to suppress the difference in film thickness of the columnar spacer and acquire a transflective liquid crystal display device of a multi-gap structure, which has little gap unevenness and an excellent display quality when the protrusion portion and the columnar spacer are formed on the same substrate.

A liquid crystal display device according to an aspect of the invention includes a liquid crystal layer interposed between a first substrate and a second substrate, a columnar space holding the liquid crystal layer, and a plurality of pixels arranged in matrix, which constitutes a display unit, wherein each of the pixels has a first display region and a second display region, and the first display region has the liquid crystal layer thinner than the second display region, a protrusion portion is formed in the first display region of the first substrate, and a columnar spacer is formed only in the second display region in which the protrusion portion is not formed.

According to an aspect of the invention, it is possible to reduce a difference in film thickness of a columnar spacer and to acquire a liquid crystal display device having little unevenness and an excellent display quality.

### BRIEF DESCRIPTION OF THE DRAWINGS

These and other objects and advantages of this invention will become more fully apparent from the following detailed description taken with the accompanying drawings in which:

FIG. 1 is a schematic plan view illustrating a liquid crystal display device according to a first embodiment of the invention;

FIG. 2 is a plan view illustrating pixels of the liquid crystal display device according to the first embodiment of the invention;

FIG. 3 is a cross-sectional view illustrating pixels of the liquid crystal display device according the first embodiment of the invention;

FIG. 4 is a cross-sectional view in which a resin film is applied for forming a columnar spacer;

FIG. 5 is a plan view illustrating pixels of a liquid crystal display device according to a second embodiment of the invention;

FIG. 6 is a plan view illustrating pixels of a liquid crystal display device according to a third embodiment of the invention;

FIG. 7 is a cross-sectional view illustrating pixels of a liquid crystal display device according to a fourth embodiment of the invention; and

FIG. 8 is a plan view illustrating pixels of a liquid crystal display device according to a fifth embodiment of the invention.

### DETAILED DESCRIPTION OF THE EMBODIMENTS

### First Embodiment

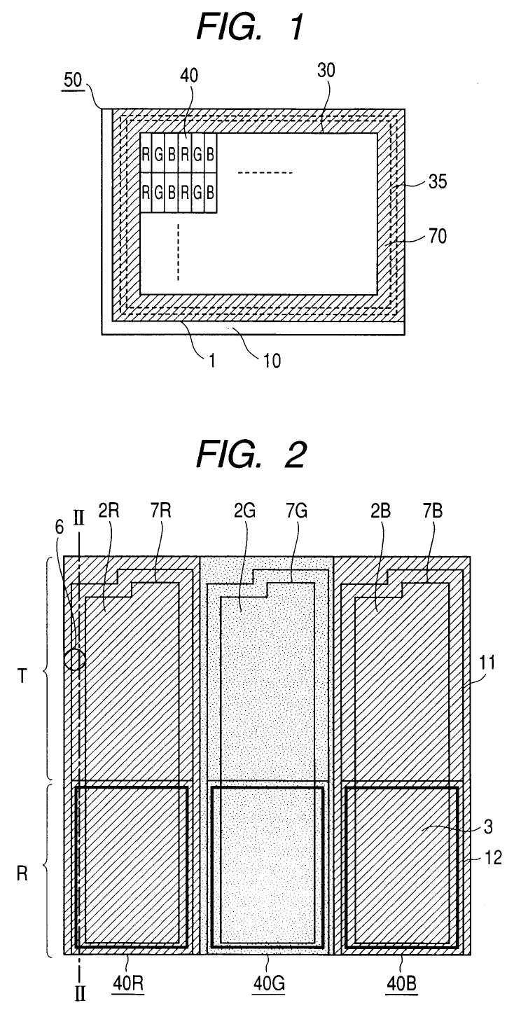

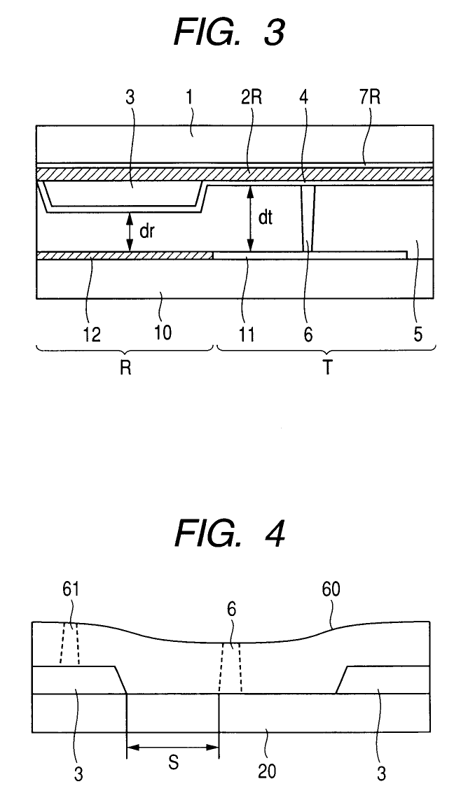

FIG. 1 is a schematic plan view illustrating a liquid crystal display device according to a first embodiment of the invention. FIG. 2 is a plan view illustrating pixels of the liquid crystal display device according to the first embodiment of the invention. FIG. 3 is a cross-sectional view taken along the line II-II of FIG. 2. Hereinafter, elements equal to or corresponding to each other are denoted by the same reference numerals in the drawings.

In FIG. 1, a liquid crystal panel 50 a color filter substrate 1 serving as a first substrate and an array substrate 10 serving as a second substrate with a liquid crystal layer 5 interposed therebetween. A display unit 30 is constituted by a plurality of pixels 40 which is arranged in matrix. A display unit circumference light shielding film 70 is formed in an outer circumference of the display unit 30 and a sealing unit 35 in which a sealing material sealing the liquid crystal layer 5 is formed is provided in the display unit circumference light shielding film 70.

Although not shown here, a polarization plate to which a retardation film is stuck is attached to a front surface and a rear surface of the liquid crystal panel 50 and a backlight is disposed on a back surface of the array substrate 10. A basic configuration thereof is the same as that of the known liquid crystal display device.

Next, primary parts will be specifically described with reference to FIGS. 2 and 3. The plurality of pixels 40 arranged in matrix which constitutes the display unit 30 of the liquid crystal display device includes three colors such as red, green, and blue and three pixels 40R, 40G, and 40B constitute a basic pixel unit for color display. The pixels 40R, 40G, and 40B have display regions having different gaps and include a reflective display region R of a reflective display serving as a first display region and a transmissive display region T of a transmissive display serving as a second display region. Here, each of the pixels 40R, 40G, and 40B has a size of 150 μm long and 50 μm wide. As shown in FIG. 2, each of the pixels 40R, 40G, and 40B are vertically divided into the transmissive display region T and the reflective display region R, but each pixel may be horizontally divided. An area ratio between the transmissive display region T and the reflective display region R can be designed in accordance with the purpose.

Here, one pixel 40 is divided into the transmissive display region T and the reflective display region R, but the transmissive display region T and the reflective display region R may be provided in different pixels.

Light shielding films 7R, 7G, and 7B composed of a metal film or a black resin are respectively formed in outer circumference portions of the pixels 40R, 40G, and 40B so as to prevent light leakage between patterns and shield a liquid crystal orientation defect region. Here, the light shielding films 7R, 7G, and 7B are composed of thin chromium oxide having a thickness of approximately 0.15 μm.

The transmissive display region T or the reflective display region R described here represents a region including an opening portion which contributes to each display mode and the light shielding films 7R, 7G, and 7B disposed at the periphery of the opening portion.

Coloring layers 2R, 2G, and 2B of three colors such as red, green, and blue are formed on a color filter substrate 1 in correspondence with the pixels 40R, 40G, and 40B. Three colors used for color display are not limited to the three colors, three colors such as yellow, magenta, and cyan may be used and a coloring layer 2 of four colors or more may be used. The coloring layers 2R, 2G, and 2B in the pixels 40 which are arranged in matrix extend in stripes to the pixels 40R, 40G, and 40B having of the same color vertically adjacent to each other.

Film thicknesses of the coloring layers 2R, 2G, and 2B are generally set to approximately 0.5 to 3.5 μm. Here, the coloring layers 2R, 2G, and 2B, and the transmissive display region T and the reflective display region R have the same film thickness of approximately 1.2 μm.

A protrusion portion 3 constituting a gap dr of the reflective display region R smaller than a gap dt of the transmissive display region T is formed on the coloring layers 2R, 2G, and 2B. The protrusion portion 3 is composed of a transparent photosensitive acrylic resin, is coated by spin coat to a desired film thickness, and is exposed and developed in a master pattern. Here, the protrusion portion 3 is formed in an island-shaped isolation pattern for each of the pixels 40R, 40G, and 40B. The reason is that a ratio of an area occupied by the protrusion portion 3 in a pixel area is reduced so as to decrease an influence of the protrusion portion 3 on formation of a columnar spacer 6, and will be specifically described later.

The protrusion portion 3 has a film thickness so that the gap dr of the reflective display region R is as larger as approximately a half the gap dt of the transmissive display region T. By this configuration, since light is only once transmitted onto the liquid crystal layer 5 in the transmissive display region T, while the light reciprocates through the liquid crystal layer 5 of in the reflective display region R, it is possible to acquire the substantially same optical distance. Here, the gap dt of the transmissive display region T is set to 3.8 μm, the gap dr of the reflective display region R is set to 2.0 μm, and the film thickness of the protrusion portion 3 is set to 1.8 μm. The protrusion portion 3 needs to be transparent so as to reciprocate through the protrusion portion 3 when it is formed on the color filter substrate 1.

An opposite electrode 4 composed of ITO (Indium Tin Oxide) is formed on an entire surface of the coloring layers 2R, 2G, and 2B, and the protrusion portion 3. However, for example, it is not necessary to form the opposite electrode 4 on the color filter substrate 1 in a mode in which a display operation is performed by shifting the liquid crystal layer 5 by an electrical field in a direction parallel to the substrate in the same manner as an IPS mode (In Plane Switching Mode).

Next, the columnar spacer 6 is formed in the transmissive display region T in which the protrusion portion 3 is not formed in an interface between the pixels 40B and 40R horizontally adjacent to each other by using the photosensitive acrylic resin in the light shielding film 7R. The columnar spacer 6 may be formed of non-photosensitive resins such as acryl and polyamide, and an inorganic material such as SiO₂, but it is preferable that it is formed of a photosensitive material so as to reduce a manufacturing process. The columnar spacer 6 is disposed substantially in the middle of end portions of the protrusions 3 of the pixel 40R vertically adjacent to each other. Accordingly, an influence of unevenness of the protrusion portion 3 can be reduced to the maximum.

In a cross-section shape of the columnar spacer 6, a diameter of a bottom face is a little thinner than that of a top face of the color filter substrate 1. In a planar shape thereof, an arbitrary shape such as a circular shape, an elliptic shape, a quadrangular shape, or a polygonal shape can be designed in the master pattern. An arrangement position, a size, and the number of the columnar spacer 6 can be arbitrarily designed by the master pattern similarly.

When the columnar spacer 6 is formed of a transparent resin, the light is transmitted onto the columnar spacer 6. Accordingly, the light shielding film 7 is also disposed in the columnar spacer 6 when light exclusion becomes a problem. When the columnar spacer 6 is formed of a block resin, it is always shielded. Thus, the light shielding film 7 needs not to be disposed therein.

However, in the periphery of the columnar spacer 6, since a thickness of an orientation film increases and a rubbing brush is not sufficiently contacted by the influence of the protrusion, it is difficult that a rubbing operation is normally performed. As a result, since a liquid crystal orientation defect easily occurs in the periphery of the columnar spacer 6, it is preferable to dispose the light shielding film 7 therein.

Here, as shown in FIG. 2, since the columnar spacer 6 is disposed in a light shielding film 7R of the interface between the pixels 40B and 40R horizontally adjacent to each other, it is possible to hide the light exclusion or the liquid crystal orientation defect and suppress an influence on a display quality without decreasing an aperture ratio.

The columnar spacer 6 is disposed only in the red pixel 40R every three pixels, but it may be disposed every the arbitrary number of pixels. For example, the columnar spacer 6 may be disposed only in one red pixel 40R every twelve pixels of 6 pixels wide and 2 pixels long.

Here, the reason whey the columnar spacer 6 is disposed in the red pixel 40R is as follows. Since the red coloring layer 2R is firstly formed in a process of forming the coloring layers 2 on the color filter substrate 1, the unevenness does not occur on the color filter substrate 1 and a uniformity of a film thickness of the red coloring layer 2R is better than the green and blue coloring layers 2G and 2B formed later. Accordingly, it is preferable that the columnar spacer 6 is formed on the coloring layer 2 firstly formed on the color filter substrate 1.

The columnar space 6 may be disposed in the blue pixel 40B without being disposed in accordance with a formation sequence of the coloring layer 2. The reason is as follows. Since a blue visibility is low as a characteristic of human's eyes, the liquid crystal orientation defect not shielded is obscure.

Next, the transmissive electrode 11 formed of a transparent conductive film such as ITO formed in the transmissive display region T serving as the pixel electrode and the reflective electrode 12 formed of a metal film having a high reflectance such as aluminum, silver, and while gold formed in the reflective display region R are formed on the array substrate 10.

In general, a scattering property is required to display white serving as a reflective display and a scattering layer is provided on a polarization plate to which a retardation plate stuck to the color filter substrate 1 is attached or a adherence material. Alternatively, a front surface of the reflective electrode 12 is uneven. Alternatively, the scattering property may be acquired by mixing fine particles with the transparent resin constituting the coloring layers 2R, 2G, and 2B or the protrusion portion 3.

Although not shown, the transmissive electrode 11 and the reflective electrode 12 are connected to a TFT (Thin Film Transistor) serving as a switching element provided in each of the pixels 40. A retention capacity unit maintaining a driving voltage is also formed.

The orientation film formed of polyamide for performing a liquid crystal orientation is formed on top layers of the color filter substrate 1 and the array substrate 10, and the rubbing operation is performed in a direction of the liquid crystal orientation.

Next, an effect of formation of the columnar spacer 6 in the transmissive display region T in which the protrusion portion 3 is not formed will be described. FIG. 4 is a cross-sectional view in which a substrate 20 on which the only protrusion portion 3 is formed is coated with a resin film 60 for forming the columnar spacer 6 by the spin coat. When a columnar spacer 61 is formed on the protrusion portion 3, the gap dt of the transmissive display region T is determined by a sum of the film thickness of the protrusion portion 3 and the film thickness of the columnar spacer 61 as described above. Accordingly, the gap dt of the transmissive display region T is influenced by both a difference in film thickness of the protrusion portion 3 and a difference in film thickness of the columnar spacer 61.

On the other hand, when the columnar spacer 6 is formed in a region in which the protrusion portion 3 is not formed, the gap dt of the transmissive display region T is determined only by a film thickness of the resin film 60 serving as the columnar spacer 6. Accordingly, it is possible to reduce a difference in gap dt of the transmissive display region T irrespective of the difference in film thickness of the protrusion portion 3.

However, as shown in FIG. 4, since the film thickness of the resin film 60 is influenced by the unevenness of the protrusion portion 3 in the periphery of the end portion of the protrusion portion 3, the difference in gap dt of the transmissive display region T increases. Accordingly, the film thickness of the resin film 60 is uniform in a region in which the columnar spacer 6 is formed in a flat region apart from the protrusion portion 3 in the region in which the protrusion portion 3 is not formed. For example, regarding a position at which the columnar spacer 6 is formed, when the end portion of the columnar spacer 6 is disposed from the end portion of the protrusion portion 3 at a distance S, it is preferable that the distance is twice or more the film thickness of the protrusion portion 3 so that the influence of the unevenness of the protrusion portion 3 is reduced. Since the film thickness of the protrusion portion 3 is generally set to 1.5 to 3.0 μm, the distance S is set to 10 μm or more.

In particular, as shown in FIG. 4, it is preferable that the columnar spacer 6 is disposed substantially in the middle of the end portions of the protrusion portions 3 adjacent to each other so that a minimum distance S between the end portion of the columnar spacer 6 and the end portion of the protrusion portion 3 has the maximum value.

When the columnar spacer 6 is formed by the spin coat, it is preferable that a ratio of an area occupied by the protrusion portion 3 in a pixel area is approximately ¾ (approximately 75%) or lower. When the rate of an area occupied by the protrusion portion 3 in the pixel area is greater than approximately ¾, the film thickness of the columnar spacer 6 may make a difference easily even in a region in which the protrusion portion 3 is not formed. The reason is as follows. When the ratio of an area occupied by the protrusion portion 3 in the pixel area is high, an area of the region in which the protrusion portion 3 is formed is dominant at the time of spin-coating the resin film 60 constituting the columnar spacer 6. Accordingly, regarding the thickness of the film formed by the spin coat, since the region in which the protrusion portion 3 is formed becomes a state of a flat reference surface of a substrate 20, while the region in which the protrusion portion 3 is not formed becomes a state of a groove portion partially formed on the substrate 20 for the thickness of the film formed by the spin coat, the difference in film thickness may occur in the groove portion easily. Accordingly, it is preferable that the influence of the protrusion 3 on formation of the columnar spacer 6 is reduced by reducing the region of the protrusion portion 3 which is not disposed in the reflective electrode 12 and does not contribute to the reflective display.

For a similar reason, when a contact hole portion (an opening portion) having a similar size as the columnar spacer 6 is formed in the reflective display region R in which the protrusion portion 3 is formed and the columnar spacer 6 is formed in the contact hole portion on the same substrate, the ratio of an area occupied by the contact hole portion in a pixel area is very low. Accordingly, a film thickness of the resin film 60 of the contact hole portion is substantially the same as the sum of the film thickness of the resin film 60 on which the columnar spacer 61 is formed on the protrusion portion 3 which does not have the contact hole portion and the film thickness of the protrusion portion 3. Since the columnar spacer 6 is adjacent to the end portion of the protrusion portion 3, the columnar spacer 6 can be easily influenced by the unevenness of the protrusion portion 3. Accordingly, the difference in film thickness of the columnar spacer 6 is hardly improved.

As described above, when the columnar spacer 6 is formed in the transmissive display region T having a larger area at a position enough apart from the end portion of the protrusion portion 3 rather than when the contact hole portion in which the protrusion portion 3 is not partially is formed and the columnar spacer 6 is disposed in the reflective display region R, it is possible to reduce the difference in film thickness.

Here, it is preferable that a diameter of the columnar spacer 6 is set to 4 μm or more. The reason is as follows. When the diameter of the columnar spacer 6 is smaller than 4 μm, the columnar spacer 6 cannot resist a load applied thereto and plastic deformation occurs therein at the time of bonding the color filter substrate 1 and the array substrate 10 with the sealing material, whereby a predetermined panel gap may not be acquired.

It is preferable that the diameter of the columnar spacer 6 is set to 30 μm or less. The reason is as follows. When minute adjustment is performed so as to adjust positions of the color filter substrate 1 and the array substrate 10 at the time of bonding the color filter substrate 1 and the array substrate 10 with the sealing material, the columnar spacer 6 having the diameter greater than 30 μm may be deformed or deviated due to a friction stress between the columnar spacer 6 and a substrate opposed thereto at the time of the minute adjustment. Since the region in which the columnar spacer 6 is formed does not contribute to display, it is preferable to reduce the region.

As described above, in the embodiment, since the columnar spacer 6 is formed in the transmissive display region T in which the protrusion portion 3 is not formed, the gap dt of the transmissive display region T is not influenced by the unevenness or the difference in film thickness of the protrusion portion 3. Accordingly, since the gap dt of the transmissive display region T becomes uniform, it is possible to acquire the liquid crystal display device having little gap unevenness and an excellent display quality.

### Second Embodiment

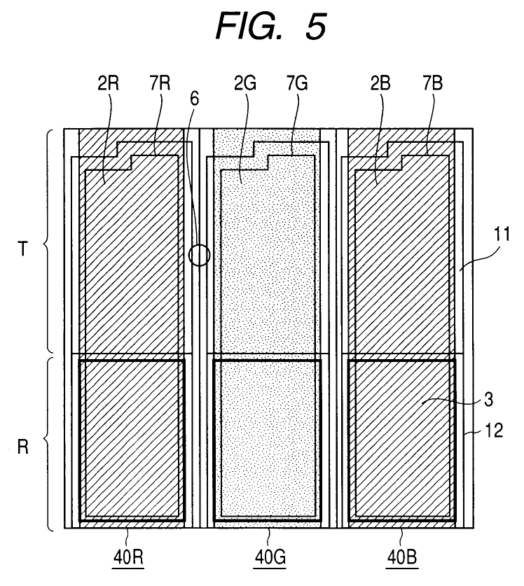

A case where the columnar spacer 6 is formed on the coloring layer 2 on which the protrusion portion 3 is not formed is disclosed in the first embodiment, but the columnar spacer 6 may be formed on a region in which the protrusion portion 3 and the coloring layer 2 are not formed, as shown in FIG. 5. Here, the coloring layers 2R and 2G are not partially formed in the range in which the light shielding films 7R and 7G are formed in the interface between the pixels 40R and 40G horizontally adjacent to each other. The region in which the coloring layers 2R, 2G, and 2B are not formed vertically extends in stripes. The columnar spacer 6 is formed in the region in which the coloring layers 2R and 2G are not formed. The columnar spacer 6 is disposed substantially in the middle of the end portions of the protrusion portions 3 of the pixels 40R and 40G vertically adjacent to each other.

In the embodiment, the columnar spacer 6 is disposed in the interface between the pixels 40R and 40G horizontally adjacent to each other, but the columnar spacer 6 is not formed on the coloring layers 2R and 2G. Accordingly, the gap dt of the transmissive display region T is not influenced by the difference in film thickness caused by partial overlapping of the coloring layers 2R and 2G by an alignment error of the coloring layers 2R and 2G.

### Third Embodiment

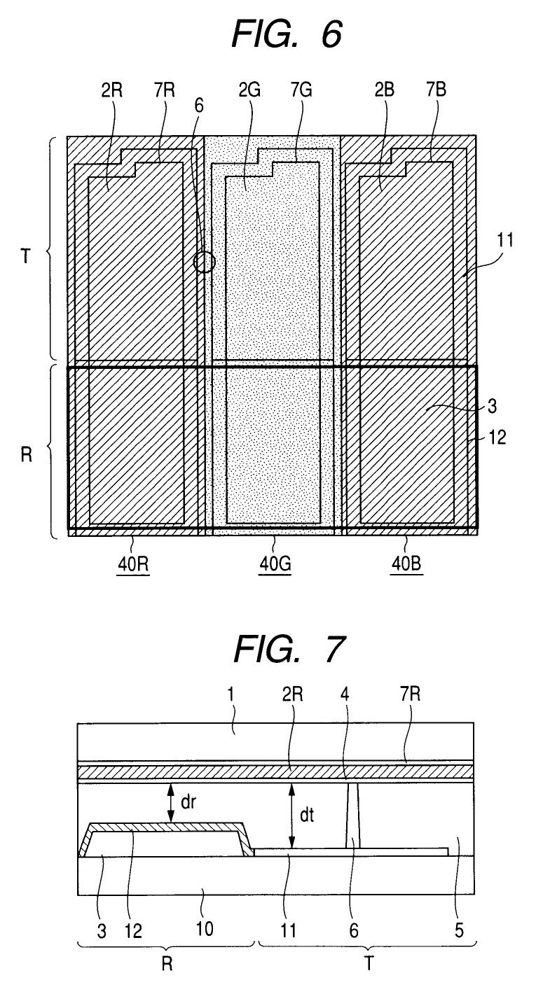

In the first and second embodiments, the protrusion portion 3 formed in the color filter substrate 1 is formed in the pixel 40 in the island-shaped isolation pattern as shown in FIGS. 2 and 5, but the protrusion portion 3 may extend in stripes to the plurality of pixels 40R, 40G, and 40B as shown in FIG. 6. Here, the columnar spacer 6 is formed in the region in which the light shielding films 7R and 7G in the transmissive display region T in which the protrusion portion 3 is not formed in the interface between the pixels 40R and 40G horizontally adjacent to each other. The columnar spacer 6 is disposed substantially in the middle of the end portions of the protrusion portions 3 in the pixels 40R and 40G vertically adjacent to each other.

In the embodiment, since the columnar spacer 6 is formed in the transmissive display region T in which the protrusion portion 3 is not formed, the gap dt of the transmissive display region T is not influenced by the unevenness or the difference in film thickness of the protrusion portion 3. Since the number of unevennesses of the protrusion portion 3 in the interface between the pixels 40 horizontally adjacent to each other can be smaller than that when the protrusion portion 3 is formed in the island-shaped isolation pattern, it is possible to suppress occurrence of the liquid crystal orientation defect which may easily occur in the unevenness portion.

### Fourth Embodiment

In the first embodiment, the protrusion portion 3 and the columnar spacer 6 are formed on the color filter substrate 1 serving as the first substrate as shown in FIG. 3, but the protrusion portion 3 and the columnar spacer 6 may be formed on the array substrate 10 serving as the first substrate 1 as shown in FIG. 7. A plan view in the embodiment is the same as that of FIG. 2. The reflective electrode 12 may be formed on the protrusion portion 3 and the columnar spacer 6 is formed in the transmissive display region T in which the protrusion portion 3 is not formed. Here, the columnar spacer 6 is formed on the array substrate 10 opposed to the light shielding film 7R in the interface between the pixels 40B and 40R horizontally adjacent to each other. The columnar spacer 6 is disposed substantially in the middle of the end portions of the protrusion portions 3 of the pixel 40R vertically adjacent to each other. Here, although the protrusion portion 3 is flat, the protrusion portion 3 may be uneven so as to provide a scattering property to the reflective electrode 12.

In the embodiment, even when the protrusion portion 3 is formed on the array substrate 10, the columnar spacer 6 is formed in the transmissive display region T in which the protrusion portion 3 is not formed, whereby it is possible to make the film thickness of the columnar spacer 6 uniform in the same manner as in the first embodiment. Since the gap dt of the transmissive display region T is not influenced by the unevenness or the difference in film thickness of the protrusion portion 3, it is possible to make the gap dt of the transmissive display region T uniform.

### Fifth Embodiment

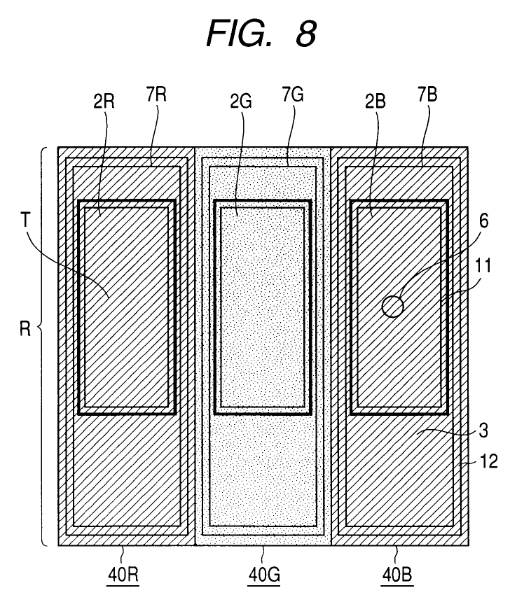

In the first embodiment, although the protrusion portion 3 is formed in the island-shaped isolation pattern, the protrusion portion 3 extends to the pixel 40 and the region in which the protrusion portion 3 is not formed may be formed in the pixel 40 in the island-shaped isolation pattern as shown in FIG. 8. In the embodiment, the transmissive display region T is surrounded by the reflective display region R. The protrusion portion 3 and the columnar spacer 6 is here formed on the array substrate 10, but they may be formed on the color filter substrate 1.

The columnar spacer 6 is formed on the transmissive electrode 11 positioned substantially in the middle of the transmissive display region T surrounded by the protrusion portion 3 of the pixel 40B. The light shielding film 7B is not disposed in the columnar spacer 6 with the emphasis on the opening rate. The reason is as follows. As described above, since the visibility of blue is low as the characteristic of human's eyes, the slight liquid crystal orientation defect is obscure. The light shielding film 7B may be disposed so as to increase a contrast.

In the embodiment, when the columnar spacer 6 is formed substantially in the middle of the transmissive display region T in which the protrusion portion 3 is not formed, it is possible to make the film thickness of the columnar spacer 6 uniform in the same manner as in the first embodiment. Since the gap dt of the transmissive display region T is not influenced by the unevenness or the difference in film thickness of the protrusion portion 3, it is possible to make the gap dt of the transmissive display region T uniform.

What is claimed is:

1. A liquid crystal display device, comprising:
a liquid crystal layer interposed between a first substrate and a second substrate;
a columnar spacer holding the liquid crystal layer; and
a plurality of pixels arranged in matrix which constitutes a display unit, wherein:
each of the pixels has a first display region and a second display region;
the first display region has the liquid crystal layer thinner than the second display region;
a protrusion portion is formed in the first display region of the first substrate; and
the columnar spacer is formed only in the second display region in which the protrusion portion is not formed.

2. The liquid crystal device according to claim 1, wherein
the columnar spacer is disposed at a position at which a light shielding film is disposed.

3. The liquid crystal display device according to claim 1, wherein
the columnar spacer is disposed at a position at which a coloring layer is not disposed.

4. The liquid crystal display device according to claim 1, wherein
the protrusion portion is formed in an island-shaped isolation pattern for the pixels.

5. The liquid crystal display device according to claim 1, wherein
the protrusion portion extends in stripes to the plurality of pixels.

6. The liquid crystal display device according to claim 1, wherein
a ratio of an area occupied by the protrusion portion in a pixel area is 75% or lower.

7. The liquid crystal display device according to claim 1, wherein
a distance between the end portion of the columnar spacer and the end portion of the protrusion portion is twice or more the film thickness of the protrusion portion.

8. The liquid crystal display device according to claim 1, wherein
the columnar spacer is disposed substantially in the middle of the end portions of the protrusion portions adjacent to each other.
